(19) United States
(12) Patent Application Publication
(10) Pub. No.: US 2016/0267214 A1
(43) Pub. Date: Sep. 15, 2016

(54) CLOCK TREE DESIGN METHODS FOR ULTRA-WIDE VOLTAGE RANGE CIRCUITS

(71) Applicant: QUALCOMM Incorporated, San Diego, CA (US)

(72) Inventors: Sung Kyu Lim, Duluth, GA (US); Francois Ibrahim Atallah, Raleigh, NC (US); Rashid Ahmed Akbar Attar, San Diego, CA (US); Keith Alan Bowman, Morrisville, NC (US); Yang Du, Carlsbad, CA (US); Juzer Zainuddin Fatehi, San Diego, CA (US); Jai Ganesh Kumar, San Diego, CA (US); Yu Pu, San Diego, CA (US); Giby Samson, San Diego, CA (US); Kendrick Hoy Leong Yuen, San Diego, CA (US)

(21) Appl. No.: 14/643,096

(22) Filed: Mar. 10, 2015

(51) Int. Cl. G06F 17/50

(52) U.S. Cl. CPC G06F 17/5081

(57) ABSTRACT

Clock tree design methods for ultra-wide voltage range circuits are disclosed. In one aspect, place and route software creates an integrated circuit (IC) in an optimal configuration at a first voltage condition. A first clock tree is created as part of the place and route process. Clock skew for the first clock tree is evaluated and minimized through insertion of bypassable delay elements. The delay elements are then removed from the wiring routing diagram. A second voltage condition is identified, and clock tree generation software is allowed to optimize the wiring routing diagram for the second voltage condition. The second clock tree generation software may insert more bypassable delay elements into the wiring routing diagram that allow clock skew optimization at the second voltage condition. The initial bypassable delay elements are then reinserted into the wiring routing diagram and a finished IC is established.

### BACKGROUND

I. Field of the Disclosure

The technology of the disclosure relates generally to designing integrated circuits (ICs).

II. Background

Computing devices, and particularly mobile communication devices, have become common in current society. The prevalence of these computing devices is driven in part by the many functions that are now enabled on such devices. Demand for such functions increases processing capability requirements and generates a need for more complex circuits. While it is possible that some of this circuitry may function asynchronously, in many cases the circuitry requires (or at least benefits from) a common clock signal. This common clock signal and corresponding clock sinks may be referred to, and represented, as a clock tree.

As the number of elements requiring a common clock signal increases, the physical distance between the clock source and a given clock sink may increase, requiring long conductors, which in turn leads to delays in arrival of the clock signal. Complicating matters is the fact that different sinks may be different distances from the clock source. The different distances mean that the clock signal will arrive at the sinks at different times. This difference is sometimes referred to as clock skew. Clock skew is of concern because it reduces the effective clock period available for computation.

While the majority of the clock skew comes from the different clock paths within the clock tree, some additional clock skew may arise from process variations between elements. Adding to the difficulty in circuit design is the advent of devices that operate at widely varying voltages. For example, wearable internet devices (e.g., Internet on Things (IoT)) may have very low power modes to extend battery life, but may also have an active mode with substantially larger voltages. Clock trees optimized for operation at a first voltage may have different clock skews at a second voltage. Accordingly, there remains a need to be able to design circuits that minimize the clock skew for multiple voltage conditions.

### SUMMARY OF THE DISCLOSURE

Aspects disclosed in the detailed description include clock tree design methods for ultra-wide voltage range circuits. In particular, exemplary aspects use place and route software to place and route components of an integrated circuit (IC) in an optimal configuration at a first voltage condition or operating under a first voltage constraint. A first clock tree is created as part of the place and route process. Clock skew for the first clock tree is evaluated and minimized through the insertion of bypassable delay elements. Once a wiring routing diagram and clock tree diagram are established, the delay elements are removed from the wiring routing diagram leaving only the bypass in the wiring routing diagram. A second voltage condition is identified (i.e., a second voltage constraint under which the IC will operate), and second clock tree generation software is allowed to optimize the wiring routing diagram (minus delay elements) generated by the initial place and route software. The second clock tree generation software may insert more bypassable delay elements into the wiring routing diagram that allow clock skew optimization at the second voltage condition. The initial bypassable delay elements are then reinserted into the wiring routing diagram and a finished IC is established. By providing clock trees that are optimized at different voltage constraints such as by choosing the right set of buffers, the clock skew may be minimized in all operating voltage states for the IC. Reduction of the clock skew in this manner improves circuit performance.

In this regard in one aspect, a method of designing an IC is disclosed. The method comprises identifying circuit elements within an IC. The method also comprises, under a first voltage constraint, using first place and route software operating to create a first clock tree diagram and a wiring routing diagram for the circuit elements within the IC including providing first bypassable delay elements as appropriate within a first clock tree. The method comprises removing the first bypassable delay elements from the first clock tree diagram and the wiring routing diagram. The method also comprises, under a second voltage constraint, using second clock tree generation software to create a second clock tree diagram for the circuit elements within the IC including providing second bypassable delay elements. The method further comprises, in the wiring routing diagram, reinserting the first bypassable delay elements to form a completed wiring routing diagram.

In another aspect, a method of designing an IC is disclosed. The method comprises identifying circuit elements within an IC. The method also comprises, under a high voltage constraint, using first place and route software operating to create a first clock tree diagram and a wiring routing diagram for the circuit elements within the IC including providing first bypassable delay elements within the first clock tree diagram such that the first clock tree diagram and the wiring routing diagram include small drivers and short wiring routes. The method comprises removing the first bypassable delay elements from the first clock tree diagram and the wiring routing diagram. The method also comprises, under a low voltage constraint, using second clock tree generation software to create a second clock tree diagram for the circuit elements within the IC including providing second bypassable delay elements within the second clock tree diagram such that the second clock tree diagram includes large drivers and long line lengths. The method further comprises, in the wiring routing diagram, reinserting the first bypassable delay elements to form a completed wiring routing diagram.

### BRIEF DESCRIPTION OF THE FIGURES

FIG. 1 is a simplified illustration of an individual wearing multiple computing devices;

FIGS. 2A and 2B are simplified diagrams of two conventional clock trees that may be concurrently used in an integrated circuit (IC) to accommodate different voltage conditions each of which has minimized clock skew;

FIG. 3 is a flowchart illustrating an exemplary process for designing an IC with a consolidated clock tree;

FIGS. 4-8 are simplified schematics of a consolidated clock tree being formed by the process of FIG. 3;

FIG. 9 illustrates a finished IC with the clock tree formed by the process of FIG. 3 in use in a high voltage condition;

FIG. 10 illustrates a finished IC with the clock tree formed by the process of FIG. 3 in use in a low voltage condition; and

FIG. 11 is a block diagram of an exemplary processor-based system that can include the IC with the clock tree designed by the process of FIG. 3.

### DETAILED DESCRIPTION

With reference now to the drawing figures, several exemplary aspects of the present disclosure are described. The word “exemplary” is used herein to mean “serving as an example, instance, or illustration.” Any aspect described herein as “exemplary” is not necessarily to be construed as preferred or advantageous over other aspects.

Aspects disclosed in the detailed description include clock tree design methods for ultra-wide voltage range circuits. In particular, exemplary aspects use place and route software to place and route components of an integrated circuit (IC) in an optimal configuration at a first voltage condition or operating under a first voltage constraint. A first clock tree is created as part of the place and route process. Clock skew for the first clock tree is evaluated and minimized through the insertion of bypassable delay elements. Once a wiring routing diagram and clock tree diagram are established, the delay elements are removed from the wiring routing diagram leaving only the bypass in the wiring routing diagram. A second voltage condition is identified (i.e., a second voltage constraint under which the IC will operate), and second clock tree generation software is allowed to optimize the wiring routing diagram (minus delay elements) generated by the initial place and route software. The second clock tree generation software may insert more bypassable delay elements into the wiring routing diagram that allow clock skew optimization at the second voltage condition. The initial bypassable delay elements are then reinserted into the wiring routing diagram and a finished IC is established. By providing clock trees that are optimized at different voltage constraints such as by choosing the right set of buffers, the clock skew may be minimized in all operating voltage states for the IC. Reduction of the clock skew in this manner improves circuit performance.

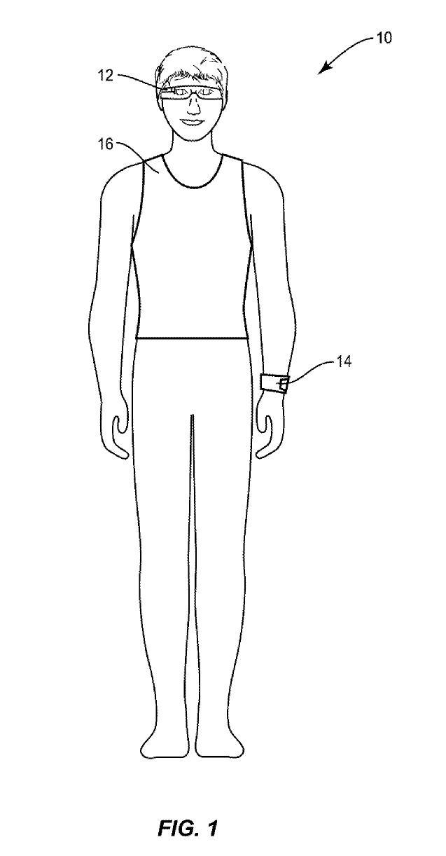

Pressure to enable ICs that operate in multiple voltage modes (i.e., under multiple voltage constraints) is increasing as a function of the advent of Internet of Things (IoT) and wearable computing devices. Such devices typically have two modes, including a standby mode where relatively low voltages are used (i.e., a low voltage constraint), and an active mode where relatively high voltages are used (i.e., a high voltage constraint). In this regard, FIG. 1 illustrates an individual 10 wearing multiple computing devices including computing eyeglasses 12 (e.g., GOOGLE® GLASS™), a computing watch 14 (e.g., APPLE® iWATCH™), and a computing shirt 16 (e.g., RALPH LAUREN® SMART SHIRT™). Each computing device (i.e., 12, 14, and 16) has at least one IC therein which may, by design, operate with at least two voltage conditions (e.g., active and standby).

It should be appreciated that different voltage conditions may create different delays among clocked elements as more time may be used in crossing threshold voltages. Different delays may disrupt the carefully generated clock tree and introduce unwanted clock skew into the circuit. In some computing devices, a second clock tree is used to make sure that the clock skew remains minimized across multiple voltage conditions.

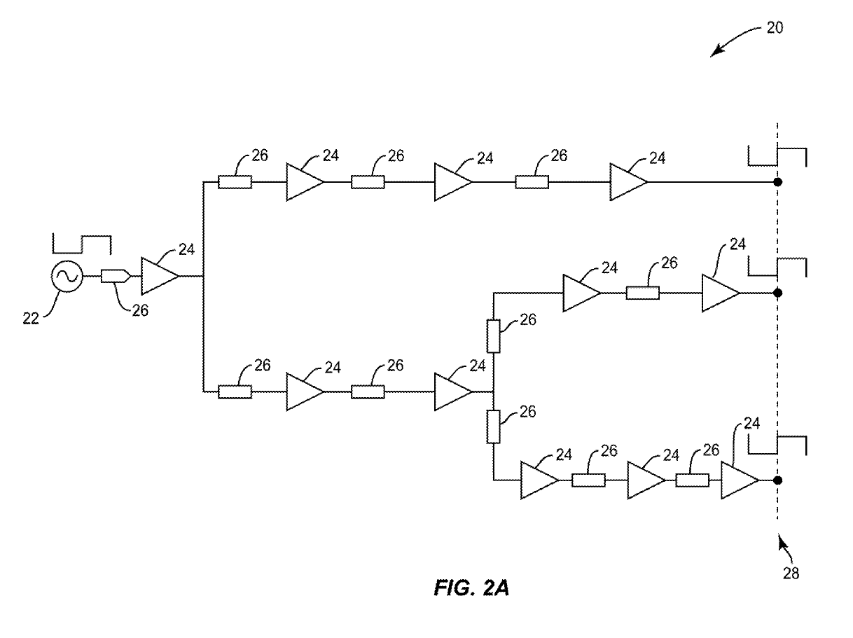

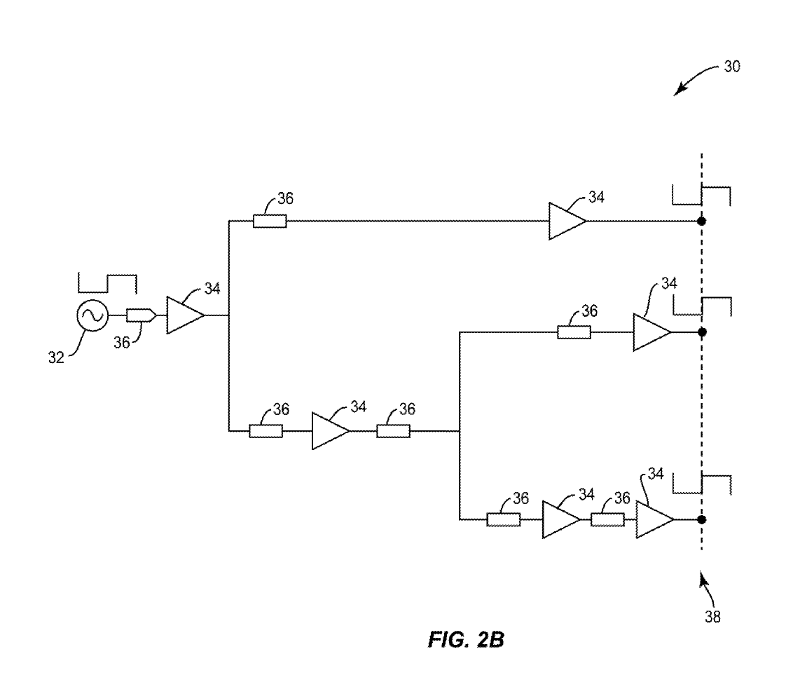

In this regard, FIG. 2A illustrates a first clock tree 20 that may be appropriate for use in an IC at comparatively high voltages (i.e., a high voltage constraint). As used herein, a high voltage is a supply voltage, which is greater than approximately 0.9 volts. The first clock tree 20 may include a clock 22 with multiple drivers 24. As used herein, a “driver” is a logical block which could also have additional signals combined with the clock signal to produce a modified clock output signal. The drivers 24 are connected by wires 26. The wires 26 are relatively short and the drivers 24 are relatively small compared to those used in a lower voltage, lower frequency mode. By making the drivers 24 relatively small and the wires 26 relatively short, clock skew (denoted by line 28) is minimized. It should be appreciated that it takes some effort to minimize the clock skew.

In contrast, FIG. 2B illustrates a second clock tree 30 that may be appropriate for use in an IC at comparatively low voltages (i.e., a low voltage constraint). As used herein, a low voltage is a supply voltage, which is approximately 500-600 mV. The second clock tree 30 may include a clock 32 with multiple drivers 34. The drivers 34 are connected by wires 36. The wires 36 are relatively long and the drivers 34 are relatively large compared to those used in a higher voltage, higher frequency mode (e.g., those used in the optimized first clock tree 20). By making the drivers 34 relatively large and the wires 36 relatively long, the number of drivers in series and associated delay variation is reduced, and clock skew (denoted by line 38) is minimized. Again, it may take some effort to minimize the clock skew in this fashion.

While using the two clock trees 20 and 30 allows an IC to operate in multiple voltage conditions with minimal clock skew at each voltage, it should be appreciated that using multiple clock trees (e.g., the clock trees 20 and 30) is expensive and consumes space. Commercial pressure makes such expensive ICs undesirable. Likewise, space, especially in mobile computing devices, is at a premium.

Exemplary aspects of the present disclosure help avoid having to use two separate clock trees (e.g., the clock trees 20 and 30) with bypassable delay elements that may be selectively bypassed depending on the voltage condition of the IC. In a low power mode, the short wires and small drivers are bypassed in favor of fewer larger drivers and longer wires. In contrast, in a high power mode, the large drivers are bypassed and more smaller drivers are used with short wires. Bypassing drivers depending on voltage constraints allows for the clock skew to be minimized across a wide range of voltage constraints. More information about bypassable drivers may be found in the co-pending U.S. patent application Ser. No. 14/642,859, filed Mar. 10, 2015, which is herein incorporated by reference in its entirety. Exemplary aspects of the present disclosure describe how to design an IC that takes advantage of the selectively bypassable delay elements of the previously incorporated co-pending U.S. patent application Ser. No. 14/642,859, filed Mar. 10, 2015.

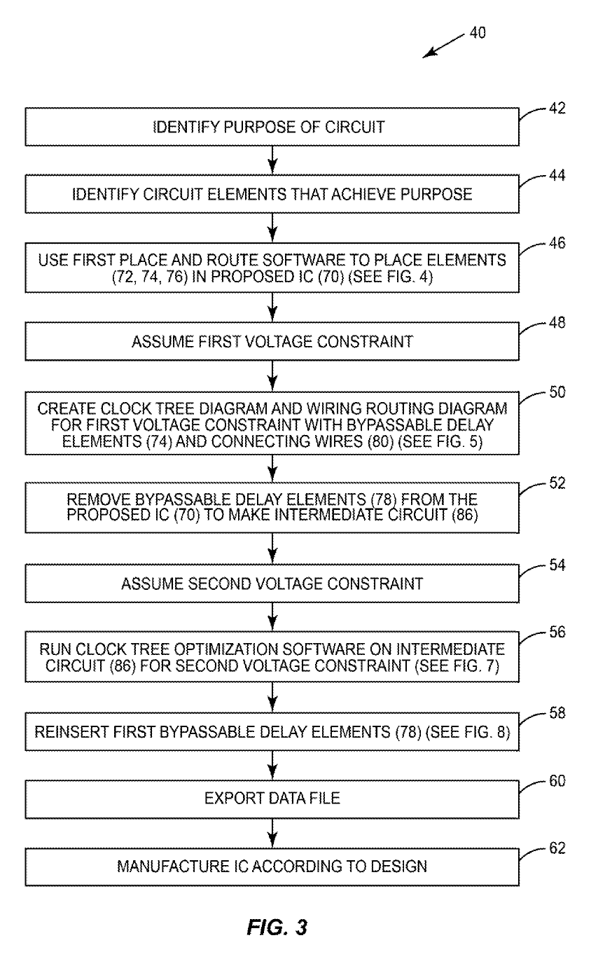

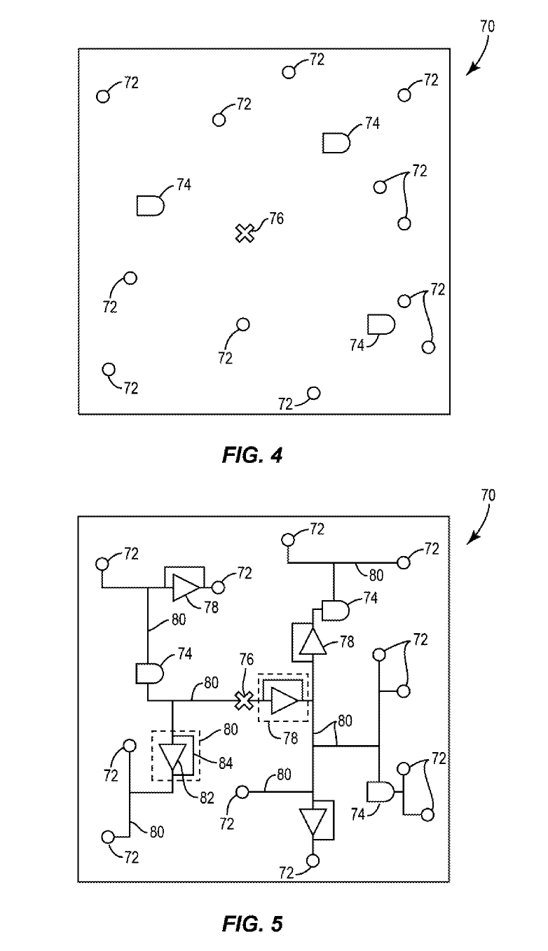

In particular, FIG. 3 provides a flow chart of a process 40 for designing an IC having a unified clock tree structure that works for an ultra-wide voltage range. The process 40 is accompanied by FIGS. 4-8 which illustrate a designed IC at various points of the process 40. The process 40 starts with the circuit designer identifying the purpose of the proposed circuit (block 42). Based on this purpose, the designer may identify circuit elements that achieve this purpose (block 44). In an exemplary aspect, the designer may use software to determine what circuit elements are used to achieve this purpose.

With continued reference to FIG. 3, the designer may further determine any additional design constraints (e.g., size, materials, pin count, frequency of operation, power budget, and the like) and use first place and route software to place elements (e.g., flip-flops 72, gate cells 74, and a clock root 76) in a proposed IC 70 (see FIG. 4) (block 46).

In this regard, FIG. 4 illustrates the proposed IC 70. The software has placed the elements (72, 74, and 76) within the boundary of the IC 70. In particular, elements such as the flip-flops 72, the gate cells 74, and the clock root 76 have been placed. It should be understood that at least the flip-flops 72 and the gate cells 74 are clocked circuit elements. Other elements, such as clock gated circuits, inverters, non-inverting buffers, delay cells, registers, and the like (not illustrated), may also be clocked circuit elements as is well understood. The software may place these elements based on one or more of the additional design constraints, to promote electromagnetic compatibility, reduce electromagnetic interference, or other criteria, as is well understood.

Returning to FIG. 3, the place and route software is instructed to assume a first voltage constraint (block 48). In an exemplary aspect, the first voltage constraint is a high voltage condition. Based on instructions to minimize the clock skew, the place and route software creates a clock tree diagram and wiring routing diagram for the first voltage condition including bypassable delay elements 78 and connecting wires 80 (see FIG. 5) (block 50).

In this regard, FIG. 5 illustrates the proposed IC 70 after the bypassable delay elements 78 and the connecting wires 80 have been generated by the place and route software. It should be appreciated that the bypassable delay elements 78 may conform to those set forth in the previously incorporated co-pending U.S. patent application Ser. No. 14/642,859, filed Mar. 10, 2015. Further, each bypassable delay element 78 may include a buffer 82 and a bypass wire 84. Operation of the bypassable delay element 78 is explained in greater detail below, but when a delay is needed, the buffer 82 is active and the bypass wire 84 is avoided. In contrast, when a delay is not needed, the buffer 82 is inactive because the signals are routed onto the bypass wire 84. Not every connecting wire 80 will have a bypassable delay element 78. Rather, the bypassable delay elements 78 are inserted so that the clock skew at each element (e.g., flip-flop 72 or gate cell 74) is minimized.

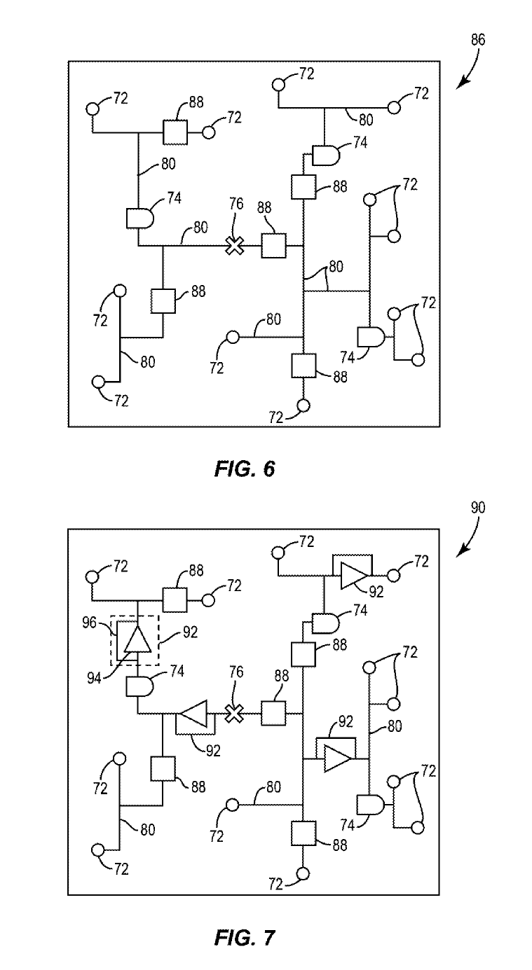

Returning to FIG. 3, the designer may then remove the bypassable delay elements 78 from the proposed IC 70 to make an intermediate circuit 86 (see FIG. 6) (block 52). In an exemplary aspect, a replacement wire 88 couples the connecting wires 80 where the bypassable delay elements 78 have been removed. In an alternate aspect, the bypass wire 84 (shown in FIG. 5) may be kept so that an electrical connection remains where the buffer 82 has been removed.

In this regard, FIG. 6 illustrates an intermediate circuit 86 with replacement wires 88 in place of bypassable delay elements 78.

Returning to FIG. 3, using the intermediate circuit 86, a second voltage constraint is assumed (block 54). In an exemplary aspect, the second voltage condition is a low voltage condition. The designer may now run second clock tree generation software on the intermediate circuit 86 for the second voltage constraint (block 56). In particular, it should be appreciated that the general wiring of the intermediate circuit 86 remains the same, but new bypassable delay elements 92 are inserted to create a second intermediate circuit 90, which effectively has a second clock tree diagram (see FIG. 7). In an exemplary aspect, the software used for block 56 may be the same as the software used for block 46. In another exemplary aspect, the software used for block 56 may be distinct from, and different from, the software used for block 46.

In this regard, FIG. 7 illustrates the second intermediate circuit 90 with the bypassable delay elements 92 inserted. When operated in the second voltage condition with the bypassable delay elements 92, the clock skew for the second intermediate circuit 90 is minimized. It should be appreciated that the bypassable delay elements 92 may include a buffer 94 and a bypass wire 96, similar to the bypassable delay elements 78. Thus, when operated in the second voltage condition, the buffers 94 are active, and the bypass wire 96 is not used. However, when operated in other voltage conditions (e.g., the first voltage condition), the bypass wire 96 is used and the buffers 94 are inactive).

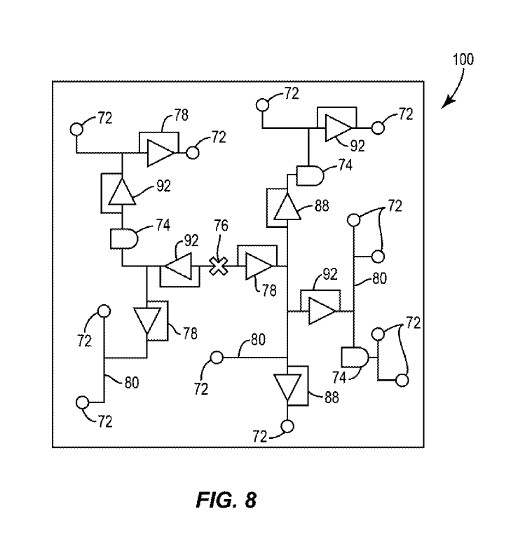

Returning to FIG. 3, the designer reinserts the first bypassable delay elements 78 into the wiring routing diagram of the second intermediate circuit 90 to create a completed wiring routing diagram 100 (see FIG. 8) (block 58). It should be appreciated that portions of the process 40 may be repeated if more than two voltage conditions are going to be present in a finalized IC. In this manner, the range of operating voltages may be expanded without the need to have multiple clock trees in the finalized IC. In this regard, FIG. 8 illustrates the completed wiring routing diagram 100 with the clock root 76 and clocked elements such as the flip-flops 72 and the gate cells 74. Additionally, both bypassable delay elements 78 and 92 are present in the completed wiring routing diagram 100. As before, the connecting wires 80 interconnect the various elements.

Returning to FIG. 3, the software used by the designer may generate a data file that reflects the completed wiring routing diagram 100. This data file may be exported (block 60) and used to manufacture an IC according to the design (block 62).

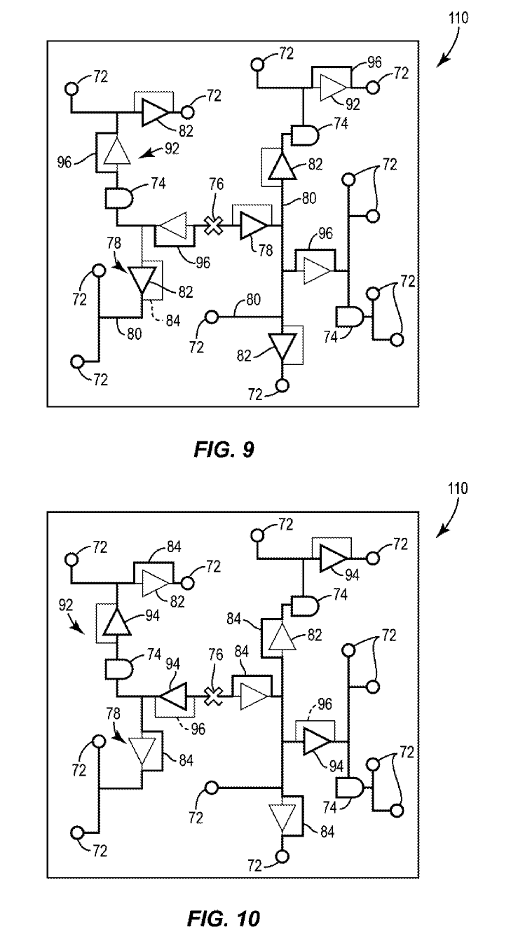

By way of further explanation, FIGS. 9 and 10 illustrate a finished IC 110 operating in a high voltage condition and a low voltage condition respectively. In FIG. 9, a control system has activated the bypass wires 96. The buffers 94 of the bypassable delay elements 92 are bypassed. Conversely, the bypass wires 84 of the bypassable delay elements 78 are not active and the buffers 82 are engaged with the connecting wires 80. In contrast, in a low voltage condition, illustrated in FIG. 10, the bypass wires 84 of the bypassable delay elements 78 are active, so that the buffers 82 are not active. The bypass wires 96 of the bypassable delay elements 92 are not active, so that the buffers 94 are engaged with the connecting wires 80. While not illustrated, if there are other voltage conditions in the design, similar switching may be used to switch in and out the appropriate buffers to minimize clock skew at each of the voltage conditions.

As noted above, utilization of exemplary aspects of the present disclosure allows the circuit designer to avoid having to use two separate and distinct clock trees (e.g., clock trees 20 and 30) each having its own wiring and buffers. In place of the two distinct clock trees (e.g., clock trees 20 and 30) a combined clock tree having a single wiring topology with two sets of buffers is used. The combined clock tree is optimized to minimize clock skew at the different voltage conditions.

The clock tree design methods for ultra-wide voltage range circuits, according to aspects disclosed herein, may be provided in, or integrated into, any processor-based device. Examples, without limitation, include: a set top box, an entertainment unit, a navigation device, a communications device, a fixed location data unit, a mobile location data unit, a mobile phone, a cellular phone, a computer, a portable computer, a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, and a portable digital video player.

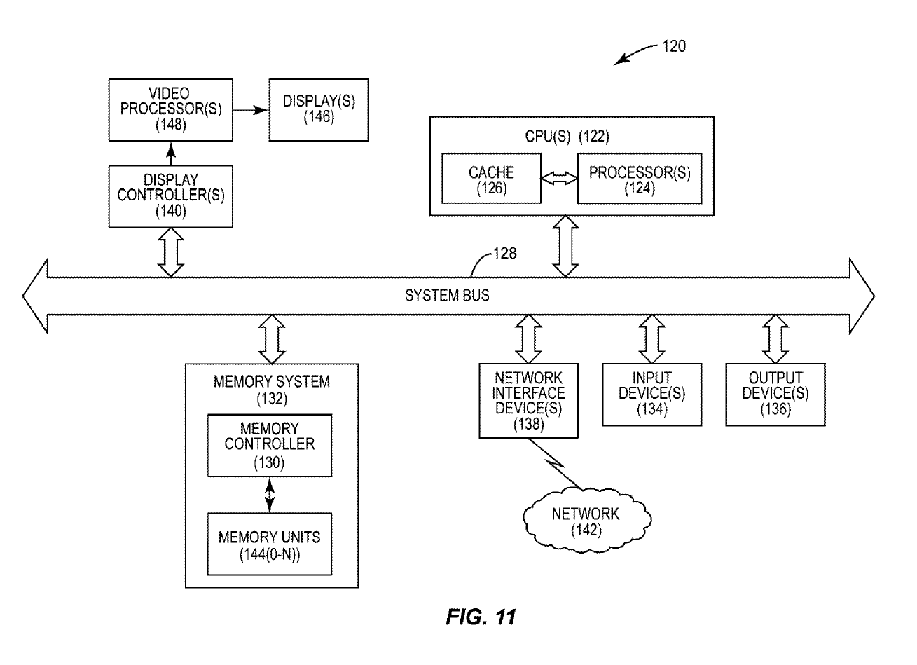

In this regard, FIG. 11 illustrates an example of a processor-based system 120 that can employ the IC 110 of FIGS. 9 and 10 designed by the process 40 of FIG. 3. In this example, the processor-based system 120 includes one or more central processing units (CPUs) 122, each including one or more processors 124. The CPU(s) 122 may have cache memory 126 coupled to the processor(s) 124 for rapid access to temporarily stored data. The CPU(s) 122 is coupled to a system bus 128 and can intercouple master and slave devices included in the processor-based system 120. As is well known, the CPU(s) 122 communicates with these other devices by exchanging address, control, and data information over the system bus 128. For example, the CPU(s) 122 can communicate bus transaction requests to a memory controller 130 as an example of a slave device. Although not illustrated in FIG. 11, multiple system buses 128 could be provided, wherein each system bus 128 constitutes a different fabric.

Other master and slave devices can be connected to the system bus 128. As illustrated in FIG. 11, these devices can include a memory system 132, one or more input devices 134, one or more output devices 136, one or more network interface devices 138, and one or more display controllers 140, as examples. The input device(s) 134 can include any type of input device, including but not limited to: input keys, switches, voice processors, etc. The output device(s) 136 can include any type of output device, including but not limited to: audio, video, other visual indicators, etc. The network interface device(s) 138 can be any devices configured to allow exchange of data to and from a network 142. The network 142 can be any type of network, including but not limited to: a wired or wireless network, a private or public network, a local area network (LAN), a wireless local area network (WLAN), and the Internet. The network interface device(s) 138 can be configured to support any type of communications protocol desired. The memory system 132 can include one or more memory units 144(0-N).

The CPU(s) 122 may also be configured to access the display controller(s) 140 over the system bus 128 to control information sent to one or more displays 146. The display controller(s) 140 sends information to the display(s) 146 to be displayed via one or more video processors 148, which process the information to be displayed into a format suitable for the display(s) 146. The display(s) 146 can include any type of display, including but not limited to: a cathode ray tube (CRT), a liquid crystal display (LCD), a plasma display, etc.

Those of skill in the art will further appreciate that the various illustrative logical blocks, modules, circuits, and algorithms described in connection with the aspects disclosed herein may be implemented as electronic hardware, instructions stored in memory or in another computer-readable medium and executed by a processor or other processing device, or combinations of both. The devices described herein may be employed in any circuit, hardware component, integrated circuit (IC), or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The aspects disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary aspects herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary aspects may be combined. It is to be understood that the operational steps illustrated in the flow chart diagrams may be subject to numerous different modifications as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but is to be accorded the widest scope consistent with the principles and novel features disclosed herein.

1. A method of designing an integrated circuit (IC), the method comprising:
identifying circuit elements within an IC;
under a first voltage constraint, using first place and route software operating to create a first clock tree diagram and a wiring routing diagram for the circuit elements within the IC including providing first bypassable delay elements as appropriate within a first clock tree;
removing the first bypassable delay elements from the first clock tree diagram and the wiring routing diagram;
under a second voltage constraint, using second clock tree generation software to create a second clock tree diagram for the circuit elements within the IC including providing second bypassable delay elements; and
in the wiring routing diagram, reinserting the first bypassable delay elements to form a completed wiring routing diagram.

2. The method of claim 1, wherein the second clock tree generation software is the first place and route software.

3. The method of claim 1, wherein the second clock tree generation software is different than the first place and route software.

4. The method of claim 1, wherein identifying the circuit elements within the IC comprises identifying one or more clocked circuit elements.

5. The method of claim 1, wherein identifying the circuit elements within the IC comprises identifying one or more elements selected from the group consisting of: a flip-flop, a clock gated circuit, an inverter, a non-inverting buffer, a delay cell, and a register.

6. The method of claim 1 wherein the first voltage constraint comprises a low voltage constraint relative to the second voltage constraint.

7. The method of claim 1, wherein the first voltage constraint comprises a high voltage constraint relative to the second voltage constraint.

8. The method of claim 1, further comprising exporting a data file reflecting the completed wiring routing diagram, such that the data file is configured to be used to manufacture an IC conforming to the completed wiring routing diagram.

9. The method of claim 1, further comprising manufacturing the IC conforming to the completed wiring routing diagram.

10. The method of claim 1, wherein using the first place and route software operating to create the first clock tree diagram and the wiring routing diagram comprises optimizing the first clock tree diagram and the wiring routing diagram for a high voltage condition through use of relatively small drivers and short wires.

11. The method of claim 10, wherein using the second clock tree generation software to create the second clock tree diagram for the circuit elements within the IC including providing the second bypassable delay elements comprises optimizing the second clock tree diagram for a low voltage condition using relatively large drivers and long wires.

12. The method of claim 9, further comprising integrating the IC into a device selected from the group consisting of: a wearable computing device; a set top box; an entertainment unit; a navigation device; a communications device; a fixed location data unit; a mobile location data unit; a mobile phone; a cellular phone; a computer; a portable computer; a desktop computer; a personal digital assistant (PDA); a monitor; a computer monitor; a television; a tuner; a radio; a satellite radio; a music player; a digital music player; a portable music player; a digital video player; a video player; a digital video disc (DVD) player; and a portable digital video player.

13. An integrated circuit (IC) made according to the method of claim 1.

14. A method of designing an integrated circuit (IC), the method comprising:
identifying circuit elements within an IC;
under a high voltage constraint, using first place and route software operating to create a first clock tree diagram and a wiring routing diagram for the circuit elements within the IC including providing first bypassable delay elements within the first clock tree diagram such that the first clock tree diagram and the wiring routing diagram include small drivers and short wiring routes;
removing the first bypassable delay elements from the first clock tree diagram and the wiring routing diagram;
under a low voltage constraint, using second clock tree generation software to create a second clock tree diagram for the circuit elements within the IC including providing second bypassable delay elements within the second clock tree diagram such that the second clock tree diagram includes large drivers and long line lengths; and
in the wiring routing diagram, reinserting the first bypassable delay elements to form a completed wiring routing diagram.

15. The method of claim 14, wherein the second clock tree diagram has fewer drivers than the first clock tree diagram.

16. The method of claim 14, wherein the second clock tree generation software is the first place and route software.

17. The method of claim 14, wherein the second clock tree generation software is different than the first place and route software.

18. The method of claim 14, wherein identifying the circuit elements within the IC comprises identifying one or more clocked circuit elements.

19. The method of claim 14, wherein identifying the circuit elements within the IC comprises identifying one or more elements selected from the group consisting of: a flip-flop, a clock gated circuit, an inverter, a non-inverting buffer, a delay cell, and a register.

20. The method of claim 14, further comprising exporting a data file reflecting the completed wiring routing diagram, such that the data file is configured to be used to manufacture an IC conforming to the completed wiring routing diagram.
